(19) United States
(12) Patent Application Publication
(10) Pub. No.: US 2025/0311066 A1
(43) Pub. Date: Oct. 2, 2025

(54) Induction Meal-Warming Panel

(71) Applicant: Guangdong Willing Technology Corporation, Huizhou (CN)

(72) Inventors: Jingnong Ye, Huizhou (CN); Shifa Luo, Huizhou (CN); Chunping Zhong, Huizhou (CN)

(21) Appl. No.: 18/749,605

(22) Filed: Jun. 20, 2024

(30) Foreign Application Priority Data
Mar. 27, 2024 (CN) 202420614451.3

(51) Int. Cl. H05B 6/12; H05B 6/06; H05B 6/40

(52) U.S. Cl. CPC H05B 6/12; H05B 6/062; H05B 6/40

(57) ABSTRACT

Disclosed in the present disclosure is an induction meal-warming panel, including at least two hobs provided adjacent to each other, wherein a flexible connecting part is provided between two adjacent hobs, two adjacent hobs are connected to each other via the flexible connecting part, at least one of the hobs is configured with a meal-warming zone, at least one of the hobs is configured with an induction-hob zone, and at least one of the hobs is foldable towards an adjacent hob via the flexible connecting part until it reaches a folded state with the adjacent hob. The structure of the present disclosure is reasonably designed to achieve cooking and meal warming at the same time. The flexible connecting part of the soft silica gel plate is connected to each hob configured with a meal-warming zone and an induction-hob zone, so that the induction meal-warming panel is portable and foldable.

### CROSS REFERENCE TO RELATED APPLICATIONS

The present application claims the benefit of Chinese Patent Application No. 202420614451.3 filed on Mar. 27, 2024, the contents of which are incorporated herein by reference in their entirety.

### FIELD

The present disclosure relates to the technical field of heat preservation and, particularly, to an induction meal-warming panel.

### BACKGROUND

Induction hobs, also known as induction cooktops, are a product of the modern kitchen revolution, which allows heat to be generated directly at a bottom of the pan without the necessity of an open flame or conductive heating. Therefore, the thermal efficiency has been greatly improved, and it is a high-efficiency and energy-saving cookware, which is completely different from the traditional open-flame or no-flame conduction heating cookware. Induction hob is an electric cookware which utilizes the principle of electromagnetic induction heating and consists of high-frequency induction heating coils, high-frequency power conversion devices, controllers, and cookware with a ferromagnetic material bottom. When using, an alternating current is introduced into the heating coil when in use, and an alternating magnetic field will be generated around the coil, and most of the magnetic lines of the alternating magnetic field pass through the metallic pan, generating a large number of eddy currents in the bottom of the pan, thereby generating the heat required for cooking. There is no open flame during the heating process, so it is both safe and hygienic.

Adopting induction hob for cooking is a very common phenomenon in modern life, induction hob has been popularized and applied in home life. With the improvement of people's quality of life, people have increasingly high requirements for cooking food, such as the request for cooking food with perfect color, flavor and taste. In home cooking, or during the cold winter months, many dishes become cold when they are brought to the table after cooking, or a few minutes after serving, which affects their texture and flavor, or even renders them inedible due to coldness, and consumption of cold food may also lead to physical discomfort, which is always a problem troubling home cook. In order to solve this problem, a solution of a meal-warming panel has been proposed in the prior art, i.e., by generating heat through a coil and transferring the heat to a front panel to preserve the heat or heat the meals in the dishes placed on the front panel. However, the existing meal-warming panels are of single structure and single function, and they are not yet able to be popularized in the family, since people usually consider the cost, the utilization rate or the storage problem of them. In order to solve this problem, proposed in the present solution is an induction meal-warming panel.

### SUMMARY

An objective of the present disclosure is to provide an induction meal-warming panel configured with both an induction-hob zone and a meal-warming zone, with both cooking and heat preservation functions to preserve or heat the first-cooked meal. By providing a flexible connecting part, it achieves a sequential connection between two adjacent hobs, so that the induction meal-warming panel is portable and foldable as a whole, which is suitable for home use or carrying on a trip.

To achieve the aforementioned objective, provided in the technical solutions of the present disclosure is an induction meal-warming panel, including at least two hobs provided adjacent to each other, wherein a flexible connecting part is provided between two adjacent hobs, two adjacent hobs are connected to each other via the flexible connecting part, at least one of the hobs is configured with a meal-warming zone, at least one of the hobs is configured with an induction-hob zone, and at least one of the hobs is foldable towards an adjacent hob via the flexible connecting part until it reaches a folded state with the adjacent hob.

Further, there are three hobs provided sequentially side by side, the induction-hob zone is configured on the hob at middle, the other two hobs are configured with the meal-warming zones, the flexible connecting part is connected between two adjacent hobs, the hob configured with the meal-warming zone is folded towards the hob configured with the induction-hob zone, and the induction-hob zone or at least one meal-warming zone is facing outside after folded.

Further, there are three hobs provided sequentially side by side, the induction-hob zone is configured on two hobs at outer sides, the middle hob is configured with the meal-warming zone, the flexible connecting part is connected between two adjacent hobs, the hob configured with the induction-hob zone is folded towards the hob configured with the meal-warming zone, and the meal-warming zone or at least one induction-hob zone is facing outside after folded.

Further, the flexible connecting part is a soft silica gel plate, and the hob is in bonding connection with the soft silica gel plate.

Further, one of the hobs is provided with a power connector, the power connector is mounted with a power line, the power line is connected with a plurality of wires, and all wires are provided in parallel and extended separately into each hob to supply power to the meal-warming zone or the induction-hob zone.

Further, a wire threading channel is provided in the flexible connecting part, the wires are threaded within the wire threading channel,
a width of the wire threading channel is 3-7 mm wider than those of the wires, and a length of the wires positioned within the wire threading channel is 1-10 mm longer than that of the wire threading channel.

Further, a front panel of the hob configured in the induction-hob zone is a glass cover, a front panel of the hob configured in the meal-warming zone is a plastic plate, both the glass cover and the plastic plate are in bonding connection with the hobs, the hob configured with the meal-warming zone is provided with a heating coil distributed uniformly, and the heating coil is abutted against a back side of the plastic plate.

Further, the plastic plate is thermally conductive rigid silica gel plate.

Further, the hob is rectangular in shape, both the glass cover and the plastic plate are rectangular in shape, and a ratio of length to width is 2:(1-1.1).

Further, a plurality of cushioning feet are fixed at a back side of the hob configured with the meal-warming zone.

In summary, the induction meal-warming panel provided in the technical solution of the present disclosure has a reasonable structural design. The induction meal-warming panel adopting the present solution provides the following beneficial effects:

The present invention includes a plurality of hobs configured with meal-warming zones and induction-hob zones respectively, and two adjacent hobs are sequentially connected via the flexible connecting part, so that the induction meal-warming panel provides cooking and meal-warming functions at the same time. By providing the flexible connecting part, it also achieves that the induction meal-warming panel is portable and foldable, which is suitable for family storage and carrying on trips.

### BRIEF DESCRIPTION OF THE DRAWINGS

FIG. 1 is a schematic structural diagram of the meal-warming panel in embodiment 1 of the present disclosure;

FIG. 2 is a schematic structural diagram in a bottom view of FIG. 1;

FIG. 3 is a schematic structural diagram in a side view of FIG. 1;

FIG. 4 is a schematic structural diagram in a combination of the flexible connecting part, a meal-warming zone, and an induction-hob zone in embodiment 1 of the present disclosure;

FIG. 5 is a schematic structural diagram in a bottom view of FIG. 4;

FIG. 6 is a schematic structural diagram in a side view of FIG. 4;

FIG. 7 is a schematic diagram of a bent structure of the meal-warming panel in embodiment 1 of the present disclosure;

FIG. 8 is a schematic diagram of a second bent structure of the meal-warming panel in embodiment 1 of the present disclosure;

FIG. 9 is a schematic diagram of a third bent structure of the meal-warming panel in embodiment 1 of the present disclosure;

FIG. 10 is a schematic structural diagram in a perspective view of the meal-warming panel in embodiment 2 of the present disclosure;

FIG. 11 is a schematic structural diagram in a bottom view of FIG. 1;

FIG. 12 is a schematic structural diagram in a side view of FIG. 1;

FIG. 13 is a schematic structural diagram of the meal-warming panel in embodiment 2 of the present disclosure removing the glass cover;

FIG. 14 is a schematic structural diagram in another perspective view of the meal-warming panel in embodiment 2 of the present disclosure;

FIG. 15 is a schematic diagram of a bent structure of the meal-warming panel in embodiment 2 of the present disclosure;

Labels: 1 meal-warming zone; 2 first flexible connecting part; 3 induction-hob zone; 301 electromagnetic coil; 302 glass cover; 4 second flexible connecting part; 5 heating coil; 6 wire-threading channel; 7 cushioning foot; 8 power connector; 9 adhesive.

### DETAILED DESCRIPTION OF THE EMBODIMENTS

The technical solutions in the embodiments of the present disclosure are clearly and completely described below in conjunction with the accompanying drawings of the present disclosure, but without limiting the scope of the present disclosure.

In the present disclosure, the following illustrations are made for better description: the observer faces the accompanying FIG. 1 for observation, the left front of the observer is set to front, the right back of the observer is set to back, the left rear of the observer is set to left, the right front of the observer is set to right, the top of the observer is set to top, and the bottom of the observer is set to bottom. It should be noted that the terms “front,” “back,” “left,” “right,” “center,” “top,” “bottom,” and the like are used in the text to indicate orientation or positional relationships based on the accompanying drawings only for the purpose of facilitating a clear description of the present disclosure and are not intended to indicate or imply that the structures or parts referred to necessarily have a particular orientation or are constructed in a particular orientation and, therefore, are not to be construed as a limitation of the present disclosure. In addition, the related terms “first”, “second”, “third” and “fourth”, if any, are used only for purposes of clarity or simplicity of description and are not to be construed as indicating or implying relative importance or quantity.

Provided in the technical solutions of the present disclosure is an induction meal-warming panel, including at least two hobs provided adjacent to each other, wherein a flexible connecting part is provided between two adjacent hobs, two adjacent hobs are connected to each other via the flexible connecting part, at least one of the hobs is configured with a meal-warming zone, at least one of the hobs is configured with an induction-hob zone, and at least one of the hobs is foldable towards an adjacent hob via the flexible connecting part until it reaches a folded state with the adjacent hob.

In the aforementioned solution, by providing a plurality of hobs configured with meal-warming zones and induction-hob zones respectively, the induction meal-warming panel provides cooking and meal-warming functions at the same time, which allows the induction meal-warming panel to have diversified functions, improves the utilization rate of the induction meal-warming panel, enables the induction meal-warming panel to be used in a hot summer, and avoids the induction meal-warming panel from being idle.

In the aforementioned solution, the flexible connecting part is adopted to achieve the connection between two adjacent hobs, so that the induction meal-warming panel is foldable, in which a length and volume of the induction meal-warming panel is effectively reduced after folded, which facilitates the storage of the induction meal-warming panel, which allows the induction meal-warming panel to be stored in a small space when not in use, or facilitates the induction meal-warming panel to be carried, facilitates the induction meal-warming panel to be used outdoors or in a car (Recreational Vehicle).

On the basis of the aforementioned technical solution, there may be provided two, three, four or more hobs. According to the cooking habit and the use habit, the hobs may be arranged in a straight line, or in an L-shape arrangement, or in a matrix arrangement. At least one hob is configured with an induction-hob zone, and at least one hob is configured with a meal-warming zone.

As shown in FIG. 1, provided in the technical solutions of the present disclosure is a schematic diagram of an embodiment of an induction meal-warming panel.

In the induction meal-warming panel of the present embodiment, there are three hobs provided sequentially side by side, the induction-hob zone is configured on the hob at middle, the other two hobs are configured with the meal-warming zones, the flexible connecting part is connected between two adjacent hobs, the hob configured with the meal-warming zone is folded towards the hob configured with the induction-hob zone when folding, and the induction-hob zone or at least one meal-warming zone is facing outside after folded.

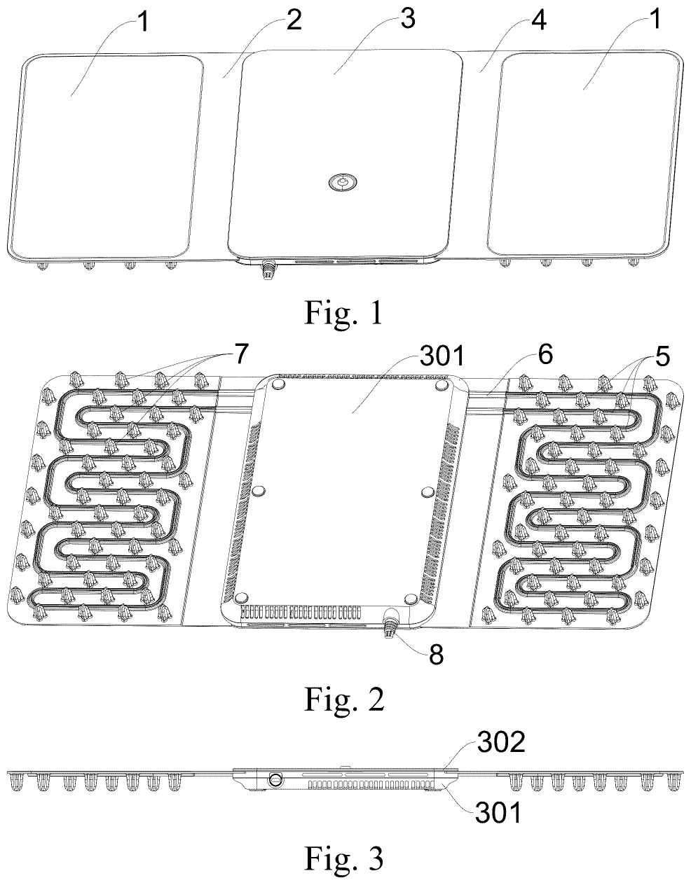

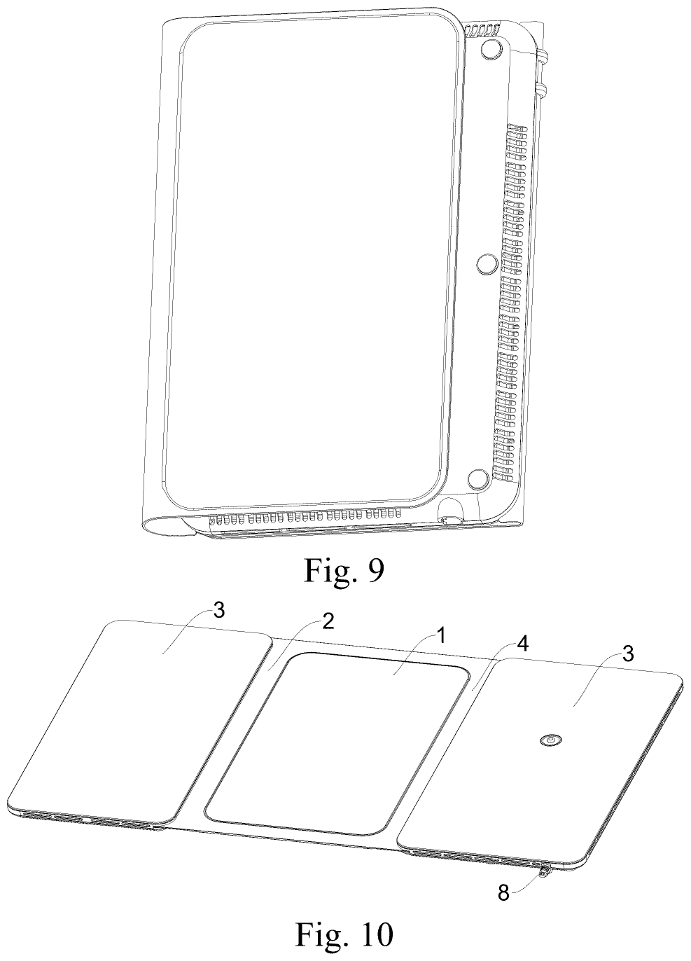

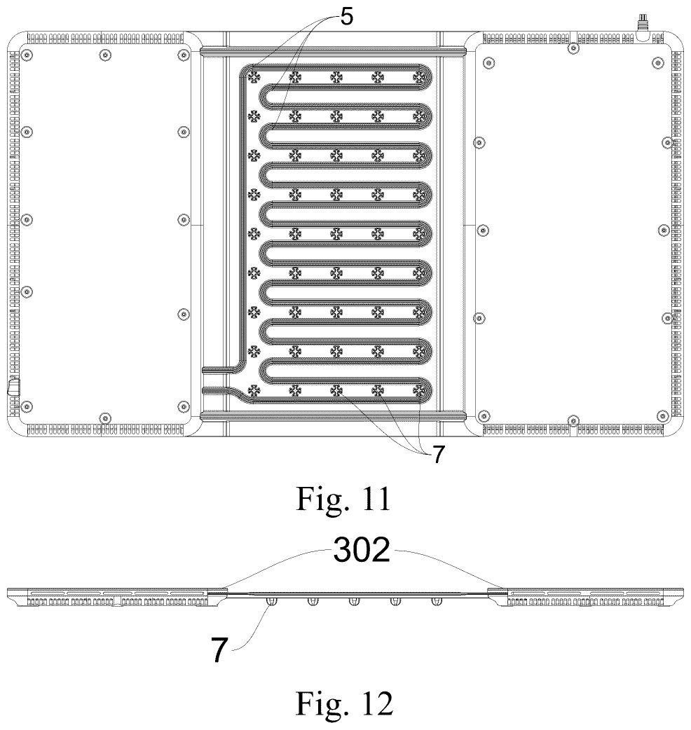

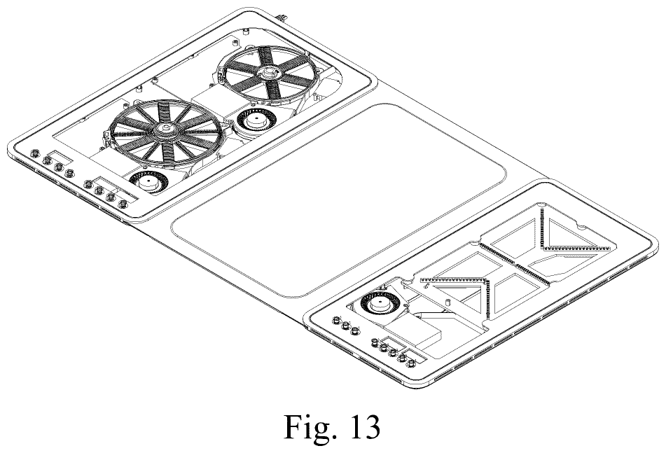

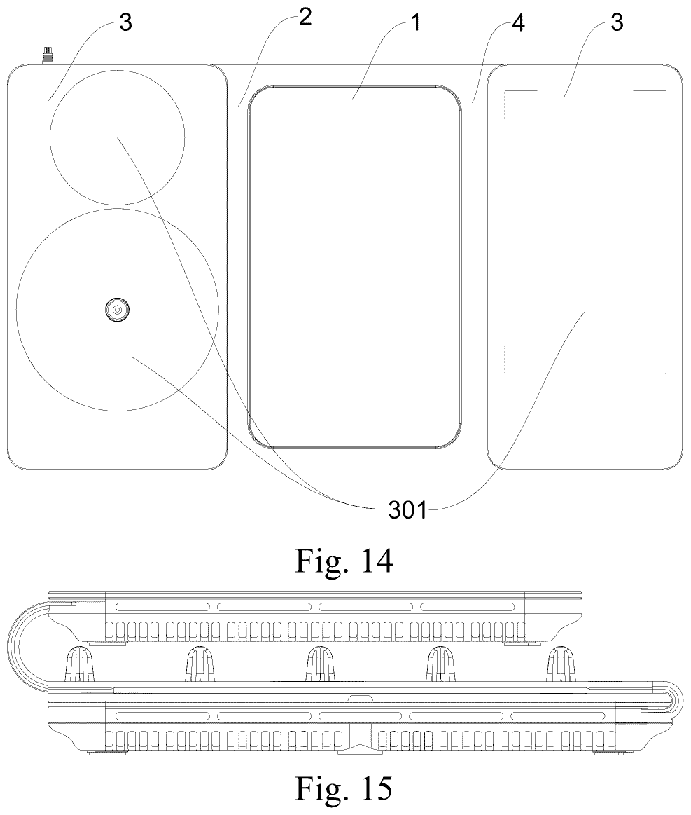

As shown in FIGS. 1-15, the induction meal-warming panel includes two meal-warming zones 1, two flexible connecting parts, and one induction-hob zone 3, in which the meal-warming zone 1 is connected to the induction-hob zone 3 via the flexible connecting part. The flexible connecting part includes a first flexible connecting part 2 and a second flexible connecting part 4. The first flexible connecting part 2 and the second flexible connecting part 4 achieve the flexible connection between two meal-warming zones 1 and one induction-hob zone 3 respectively.

In the present embodiment, there are provided three hobs arranged side by side, the induction-hob zone is configured on the hob at middle, and the meal-warming zones are configured on the hobs at outer sides. It conforms to people's cooking and operating habits, and there are more meal-warming zones, which may keep warm and heat up the dishes that are cooked first, so that cooking and meal warming are achieved at the same time.

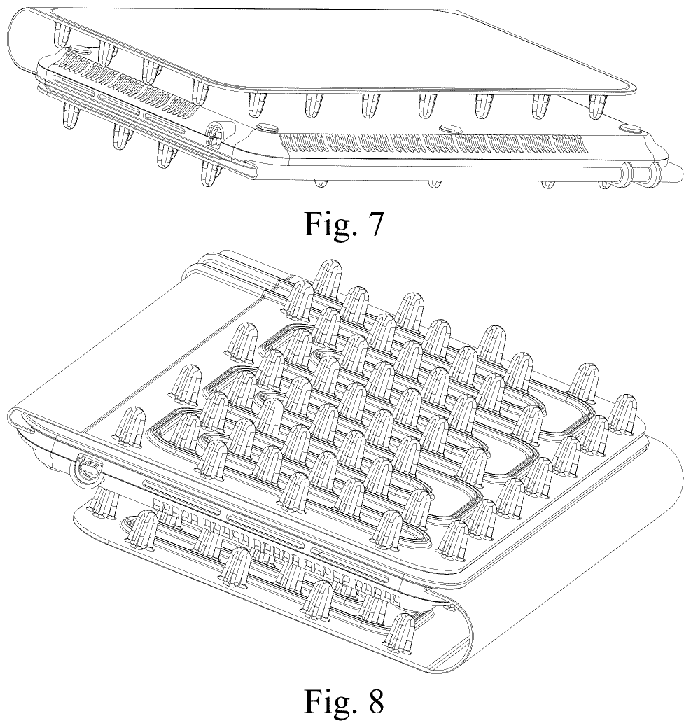

Additionally, after the induction meal-warming panel of the present embodiment is folded, as shown in FIGS. 7-9, the induction-hob zone or at least one meal-warming zone is facing outside, so that the folded induction meal-warming panel is also capable of meal warming or cooking. At this moment, the induction meal-warming panel is of a relatively small structure and takes up little space.

Based on the solution of the present embodiment, the induction meal-warming panel may be used unfolded or folded according to the need, so that cooking and meal-warming operations may be carried out simultaneously, or the meal-warming or cooking work may be carried out separately. When the induction-hob zone is facing outside, meals that need to be warmed or heated may also be placed on the induction-hob zone to achieve rapid heating and warming of the meals.

Based on the solution of the present embodiment, after the induction meal-warming panel is folded, it is also convenient to pack and store the induction meal-warming panel, which facilitates the carrying of the induction meal-warming panel, and facilitates the use of the induction meal-warming panel outdoors or in a vehicle. This allows the present induction meal-warming panel to not only have more functions for use, but also an increase of the scenarios in which it is used, which greatly improves the usage rate of the induction meal-warming panel.

As shown in FIG. 10, provided in the technical solutions of the present disclosure is a schematic diagram of another embodiment of an induction meal-warming panel.

In the induction meal-warming panel of the present embodiment, there are three hobs provided sequentially side by side, the induction-hob zone is configured on two hobs at outer sides, the middle hob is configured with the meal-warming zone, the flexible connecting part is connected between two adjacent hobs, the hob configured with the induction-hob zone is folded towards the hob configured with the meal-warming zone, and the meal-warming zone or at least one induction-hob zone is facing outside after folded.

As shown in FIG. 10, the induction meal-warming panel includes a meal-warming zone 1, two flexible connecting parts, and two induction-hob zones 3, and the meal-warming zone 1 is connected to the induction-hob zone 3 via the flexible connecting part. The flexible connecting part includes a first flexible connecting part 2 and a second flexible connecting part 4. The first flexible connecting part 2 and the second flexible connecting part 4 achieve the flexible connection between two induction-hob zones 3 and one meal-warming zone 1 respectively.

In the present embodiment, there are provided three hobs arranged side by side, the meal-warming zone is configured on the hob at middle, and induction-hob zones are configured on two hobs at outer sides. It also conforms to people's cooking and operating habits, and there are more induction-hob zones, which allows for the rapid completion of dishes, enabling simultaneous multi-cooking and improving the cooking speed, in addition to the middle meal-warming zone, which is also able to keep warm and heat up the dishes that are cooked first, so that cooking and warming are achieved at the same time. In the present embodiment, the meal-warming zone is provided at the middle, which avoids the problem of mutual interference or the inability to perform the cooking operation when cooking on both left and right induction-hob zones simultaneously. By providing the meal-warming zone at the middle, the left and right induction-hob zones allow two operators to stand nearby for cooking operations, with plenty of room for operation.

Additionally, as shown in FIG. 15, after the induction meal-warming panel of the present embodiment is folded, the induction-hob zone or at least one meal-warming zone is facing outside, so that the folded induction meal-warming panel is also capable of meal warming or cooking. At this moment, the induction meal-warming panel is of a relatively small structure and takes up little space.

When the induction-hob zone is facing outside, meals that need to be warmed or heated may also be placed on the induction-hob zone to achieve rapid heating and warming of the meals.

Based on the solution of the present embodiment, the induction meal-warming panel may be used unfolded or folded according to the need, so that cooking and meal-warming operations may be carried out simultaneously, or the meal-warming or cooking work may be carried out separately.

Based on the solution of the present embodiment, after the induction meal-warming panel is folded, it is also convenient to pack and store the induction meal-warming panel, which facilitates the carrying of the induction meal-warming panel, and facilitates the use of the induction meal-warming panel outdoors or in a vehicle. This allows the present induction meal-warming panel to not only have more functions for use, but also an increase of the scenarios in which it is used, which greatly improves the usage rate of the induction meal-warming panel.

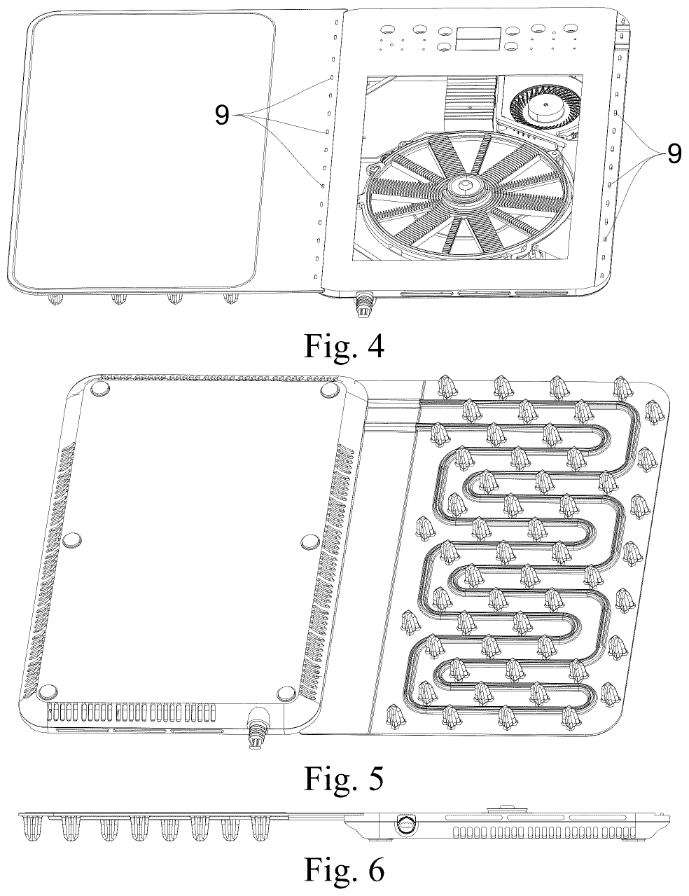

In order to simplify the structure of the flexible connecting part, as well as to simplify the connection between the flexible connecting part and each hob, in the present solution, the flexible connecting part is made of a soft silica gel plate, and the hob is in bonding connection with the soft silica gel plate. The specific adhesive used for bonding is silicone adhesive. As shown in FIG. 4, when bonding, the adhesive 9 is uniformly applied to the side of the hob near the soft silica gel plate, and then the soft silica gel plate is abutted against the hob at the position where the adhesive is applied, so that the adhesive 9 bonds the soft silica gel plate to the hob.

In the present solutions, one of the hobs on the induction meal-warming panel is provided with a power connector 8, the power connector 8 is mounted with a power line, the power line is connected with a plurality of wires, and all wires are provided in parallel and extended separately into each hob to supply power to the meal-warming zone or the induction-hob zone. One power connector 8 is provided to introduce a power line, and all hobs share the present power line, which allows the induction meal-warming panel to be connected to only one power supply or one plug.

Further, the power connector 8 is provided on a side of the hob, which saves space for the present induction meal-warming panel as a whole, and it is also aesthetic and decent.

Further, in the present solution, a wire-threading channel 6 is provided within the flexible connecting part, wires are threaded through the wire-threading channel 6, so that the wire-threading channel protects the wires, avoiding the wires from being exposed leading to wear and tear of the wires, avoiding short-circuiting and breaking of wires.

Further, a width of the wire threading channel is 3-7 mm wider than those of the wires, and a length of the wires positioned within the wire threading channel is 1-10 mm longer than that of the wire threading channel. The design of the surplus length of wires in the wire-threading channel allows the wires not to be tensioned when folding the hobs. If the wire surplus segment is not provided, the wire is tensioned when folding the hobs. Therefore, it avoids breakage or disconnection of the wires and avoids safety hazards, and also reduces the failure rate of the induction meal-warming panel and prolongs the service life of the present induction meal-warming panel.

Further, in the present solution, a front panel of the hob configured in the induction-hob zone is a glass cover, and a front panel of the hob configured in the meal-warming zone is a plastic plate. The induction-hob zone adopts the glass cover as the front panel, which is heat-resistant and suitable for high temperature cooking. The meal-warming zone adopts the plastic plate as the front panel, which, on the one hand, avoids excessive temperature, affecting the taste of food, and also avoids the problem of burns when the human body touches the meal-warming plate, and, on the other hand, has a relatively low cost and light weight, which reduces the overall manufacturing cost and weight of the induction meal-warming panel.

The plastic plate is thermally conductive rigid silica gel plate. Thermally conductive rigid silica gel plate has a Shore hardness of 70HA. Thermally conductive silica gel plate has a trace deformability. The present invention adopts a thermally conductive rigid silica gel plate as the front panel of the meal-warming zone, so that there is a slight elasticity in the meal-warming zone that allows for a better fit with the dishes containing the meals and a more stable placement, and the bottom of the dishes is heated more uniformly.

Both the glass cover and the plastic plate are in bonding connection with the hobs, the hob configured with the meal-warming zone is provided with a heating coil 5 distributed uniformly, and the heating coil 5 is abutted against a back side of the plastic plate. The heating coil is energized to generate heat and transfer the heat to the plastic plate to achieve heating of the dishes placed on the plastic plate.

An electromagnetic coil 301 is configured at a bottom of the glass front panel of the induction-hob zone, and the electromagnetic coil 301 is energized and operates to enable the induction-hob zone to achieve a cooking operation. Conventionally, the current within the electromagnetic coil 301 is controlled by the power switch and the gear adjustment switch, which achieves the control of the output working power of the electromagnetic coil 301 and achieves cooking at different temperatures to meet the cooking requirements.

In the present solution, the hob is rectangular in shape, both the glass cover 302 and the plastic plate are rectangular in shape, and a ratio of length to width is 2:(1-1.1). A length direction of the induction meal-warming panel as a whole is a width direction of the hob. Generally, a length of the glass cover and the plastic plate is designed to be 840 mm, and a width of the glass cover 302 and the plastic plate is substantially half of their lengths. The dimensions of the glass cover 302 are designed to meet the size requirements of a majority of cookware in the prior art, allowing for cooking to be accomplished using a majority of cookware in the prior art for cooking.

In order to avoid the problem of the top corners of the induction meal-warming panel causing damage to personnel when folding or unfolding the meal-warming panel, the top corners of the glass cover and the plastic plate are provided with rounded corners in the present solution.

In the present solution, a plurality of cushioning feet 7 are fixed at a back side of the hob, configured with the meal-warming zone. The cushioning foot 7 is made of silica gel or rubber, which is wear-resistant and anti-slip, and it supports the hob configured with the meal-warming zone, so that the plastic plate of the meal-warming zone is of the same height as the glass front panel of the induction-hob zone.

In addition, the cushioning feet are provided so that the cushioning feet or the back side of the hob of the induction-hob zone is facing outside after the present induction meal-warming panel is folded, which allows the folded induction meal-warming panel to be flatly placed and to work as well.

In the above implementation, the cushioning foot 7 is conical, with good strength, not easy to be deformed, good support capacity, and easy to be produced and processed.

The above described are preferred embodiments of the present disclosure. It should be noted that for those skilled in the art, a plurality of improvements and modifications may be made without departing from the principles of the present disclosure, which should also be considered as the scope of protection of the present disclosure.

1. An induction meal-warming panel, comprising at least two hobs provided adjacent to each other, wherein a flexible connecting part is provided between two adjacent hobs, two adjacent hobs are connected to each other via the flexible connecting part, at least one of the hobs is configured with a meal-warming zone, at least one of the hobs is configured with an induction-hob zone, and at least one of the hobs is foldable towards an adjacent hob via the flexible connecting part until it reaches a folded state with the adjacent hob.

2. The induction meal-warming panel according to claim 1, wherein there are three hobs provided sequentially side by side, the induction-hob zone is configured on the hob at middle, the other two hobs are configured with the meal-warming zones, the flexible connecting part is connected between two adjacent hobs, the hob configured with the meal-warming zone is folded towards the hob configured with the induction-hob zone, and the induction-hob zone or at least one meal-warming zone is facing outside after folded.

3. The induction meal-warming panel according to claim 1, wherein there are three hobs provided sequentially side by side, the induction-hob zone is configured on two hobs at outer sides, a middle hob is configured with the meal-warming zone, the flexible connecting part is connected between two adjacent hobs, the hob configured with the induction-hob zone is folded towards the hob configured with the meal-warming zone, and the meal-warming zone or at least one induction-hob zone is facing outside after folded.

4. The induction meal-warming panel according to claim 1, wherein the flexible connecting part is a soft silica gel plate, and the hob is in bonding connection with the soft silica gel plate.

5. The induction meal-warming panel according to claim 2, wherein the flexible connecting part is a soft silica gel plate, and the hob is in bonding connection with the soft silica gel plate.

6. The induction meal-warming panel according to claim 3, wherein the flexible connecting part is a soft silica gel plate, and the hob is in bonding connection with the soft silica gel plate.

7. The induction meal-warming panel according to claim 1, wherein one of the hobs is provided with a power connector, the power connector is mounted with a power line, the power line is connected with a plurality of wires, and all wires are provided in parallel and extended separately into each hob to supply power to the meal-warming zone or the induction-hob zone.

8. The induction meal-warming panel according to claim 2, wherein one of the hobs is provided with a power connector, the power connector is mounted with a power line, the power line is connected with a plurality of wires, and all wires are provided in parallel and extended separately into each hob to supply power to the meal-warming zone or the induction-hob zone.

9. The induction meal-warming panel according to claim 3, wherein one of the hobs is provided with a power connector, the power connector is mounted with a power line, the power line is connected with a plurality of wires, and all wires are provided in parallel and extended separately into each hob to supply power to the meal-warming zone or the induction-hob zone.

10. The induction meal-warming panel according to claim 7, wherein a wire threading channel is provided in the flexible connecting part, the wires are threaded within the wire threading channel, a width of the wire threading channel is 3-7 mm wider than those of the wires, and a length of the wires positioned within the wire threading channel is 1-10 mm longer than that of the wire threading channel.

11. The induction meal-warming panel according to claim 1, wherein a front panel of the hob configured in the induction-hob zone is a glass cover, a front panel of the hob configured in the meal-warming zone is a plastic plate, both the glass cover and the plastic plate are in bonding connection with the hobs, the hob configured with the meal-warming zone is provided with a heating coil distributed uniformly, and the heating coil is abutted against a back side of the plastic plate.

12. The induction meal-warming panel according to claim 2, wherein a front panel of the hob configured in the induction-hob zone is a glass cover, a front panel of the hob configured in the meal-warming zone is a plastic plate, both the glass cover and the plastic plate are in bonding connection with the hobs, the hob configured with the meal-warming zone is provided with a heating coil distributed uniformly, and the heating coil is abutted against a back side of the plastic plate.

13. The induction meal-warming panel according to claim 3, wherein a front panel of the hob configured in the induction-hob zone is a glass cover, a front panel of the hob configured in the meal-warming zone is a plastic plate, both the glass cover and the plastic plate are in bonding connection with the hobs, the hob configured with the meal-warming zone is provided with a heating coil distributed uniformly, and the heating coil is abutted against a back side of the plastic plate.

14. The induction meal-warming panel according to claim 11, wherein the plastic plate is thermally conductive rigid silica gel plate.

15. The induction meal-warming panel according to claim 12, wherein the plastic plate is thermally conductive rigid silica gel plate.

16. The induction meal-warming panel according to claim 13, wherein the plastic plate is thermally conductive rigid silica gel plate.

17. The induction meal-warming panel according to claim 11, wherein the hob is rectangular in shape, both the glass cover and the plastic plate are rectangular in shape, and a ratio of length to width is 2:(1-1.1).

18. The induction meal-warming panel according to claim 12, wherein the hob is rectangular in shape, both the glass cover and the plastic plate are rectangular in shape, and a ratio of length to width is 2:(1-1.1).

19. The induction meal-warming panel according to claim 13, wherein the hob is rectangular in shape, both the glass cover and the plastic plate are rectangular in shape, and a ratio of length to width is 2:(1-1.1).

20. The induction meal-warming panel according to claim 1, wherein a plurality of cushioning feet are fixed at a back side of the hob configured with the meal-warming zone.
